(19) United States
(12) Patent Application Publication
(10) Pub. No.: US 2007/0201164 A1
(43) Pub. Date: Aug. 30, 2007

(54) DATA STORAGE DEVICE WITH HARD DRIVE AND INTERCHANGEABLE DATA STORAGE DISKS

(76) Inventors: Randall Clement Bauck, Boulder, CO (US); David E. Jones, Layton, UT (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/563,415

(22) Filed: Nov. 27, 2006

Related U.S. Application Data
(60) Provisional application No. 60/740,003, filed on Nov. 28, 2005.

(51) Int. Cl. G11B 17/08; G11B 19/02

(52) U.S. Cl. 360/98.04; 360/69

(57) ABSTRACT

A data storage device is provided having a drive hub that may be utilized with a plurality of individual data storage disks that are selectively engageable with the drive hub. In such an arrangement, a plurality of data storage disks may be stored in an inactive state at a storage location and selectively retrieved in an automated process for engagement with the drive hub. Once engaged with the drive hub, data may be accessed from the data storage disk and/or data may be written to the data storage disk. The device allows use of multiple data storage disks with a single drive hub and corresponding sets of read-write heads thereby reducing the per disk cost for storage purposes. The device may be utilized for large scale data storage and/or data back-up applications. In one arrangement, multiple devices may be utilized together in, for example, a RAID configuration.

### CROSS REFERENCE TO RELATED APPLICATION

This application claims priority under 35 U.S.C. §119 to U.S. Provisional Application No. 60/740,003 entitled: “A Data Storage Device,” having a filing date of Nov. 28, 2005, the contents of which are incorporated herein by reference.

### FIELD

The present disclosure is directed to computer storage devices. More specifically the present disclosure is directed to computer storage devices having removable data storage disks and storage systems utilizing such devices.

### BACKGROUND

Most computers use magnetic hard drives for storage of digital information for which immediate access is required. Typically, these magnetic hard drives store the information on rigid disks made of either aluminum or glass. The surfaces of the disks are coated with various thin layers one of which is magnetically alterable. The hard drive also contains read/write heads that are positioned close to the surface of the disk by electronics and firmware in the drive. The read/write heads are able to magnetically alter the magnetic layer on the surfaces of the disks in order to store data. The detail of how a magnetic hard drive works is well known to those skilled in the art. In order to reduce the amount of data stored on such hard drives, data that does not require immediate access may be archived or otherwise stored “off-line.” In many cases, tape drives or other non-disk media have been employed for this purpose.

Because of the cost of the read/write heads and the magnetic disks and space requirements, the developers of magnetic hard drives try to maximize the amount of data that may be stored on each disk. This yields the most data capacity for the lowest cost. In some applications, it is required that more data be stored on the hard drive than a single disk and two heads (i.e. which are positionable on opposing surfaces of the disk) can achieve. In this case, more disks and more heads may be added to the hard drive to achieve the target capacity. Typically, there are two read/write heads, one for each disk surface, for each disk that is added. Thus a given capacity may be achieved but with the penalty of extra cost. There is also additional cost associated with the electronics, the actuator (which is used to position the read/write heads), and the housing used to contain these components (e.g., a cast aluminum enclosure).

In hard drives that incorporate multiple disks, the disks are rigidly mounted on a spin motor (e.g., a spindle) and spaced apart so that the read/write heads may reach each disk surface. Great precision is required in the mechanical positioning of the disks on the motor, and the heads with respect to the disks. Therefore, it is impractical to continually add disks and heads to achieve a desired capacity, since the mechanical tolerances beyond about three disks becomes cost prohibitive. Accordingly, the storage capacity of hard drives has been limited by physical constraints as well as cost constraints.

To increase the storage capacity as well as other operating parameters of a hard drive, multiple hard drives are sometimes utilized. For instance, arrays of hard drive may be utilized to share and/or replicate data among the drives. In computing, the acronym RAID (i.e., Redundant Array of Independent Disks) refers to a data storage scheme using multiple hard drives to share or replicate data among the drives. Depending on the configuration of the RAID (typically referred to as the RAID level), the benefit of RAID is one or more of increased data integrity, fault-tolerance, throughput and/or capacity compared to single drives. In its original implementations, one advantage was the ability to combine multiple devices using older technology into an array that offered greater capacity, reliability, and/or speed, than was affordably available in a single device using the newest technology.

There are various RAID levels or configurations that have been defined and standardized in the computer storage industry. Depending on the particular RAID level, failure of one drive in the array will, at a minimum, allow data previously stored on the array to be recovered, and for the more sophisticated RAID levels, continue to operate (i.e., record and recover data) while the failed drive is removed and replaced. While such RAID configurations allow for increasing the storage capacity of a computer system using multiple hard drives, each drive is still subject to physical constraints regarding the number of disks that may be utilized be each drive and the cost constrains of requiring read/write heads and associated electronics for each disk.

Due to the constraints of hard drives, applications requiring low cost, high capacity storage have typically utilized different storage media. For instance, magnetic tape has been utilized as the storage media for many high capacity storage applications (e.g., archiving or off-line storage) as the tape is inexpensive and multiple individual tape cartridges may be integrated into a single unit and may in some instances share one or more common read/write heads. In some applications (e.g., silo farms) thousands of tape cartridges may be stored in a common facility. Such cartridges may be then be utilized with several common sets of read/write heads. For instance, two sets of read/write heads may be operative to simultaneously write data to two separate tapes to generate a back-up copy of a set of data. Likewise separate read/write heads may split data between separate tapes to improve data throughput.

### SUMMARY OF THE INVENTION

In view of the limitations of the prior art, use of hard drives has not been a cost effective solution for large off-line data storage facilities (e.g., archival storage of data) such as data silos and/or for many data back-up applications. Accordingly, it has been recognized that the ability to use multiple data storage disks with a single set of read-write heads could alleviate many of the limitations of the prior art and allow for hard drive storage devices to be utilized for large scale data storage as well as data back-up applications. In such an arrangement, a number of data storage disks may be stored in an inactive state at a storage location and selectively retrieved in an automated process for accessing data therefrom and/or writing data thereto. In addition, one or more selected data storage disks may be securely engaged with a drive hub associated with a set of read-write heads. That is, a single drive hub and a set of read-write heads may be utilized with a plurality of individual data storage disks that are selectively engageable with the drive hub. Such an arrangement eliminates the need of individual read-write heads for individual disks and overcomes previous tolerance problems that typically restricted storage devices to use of no more than about three disks fixedly mounted to a common spindle.

According to one aspect, a data storage device and method (i.e., utility) are provided. The utility includes a plurality of data storage disks in an inactive state in a storage location and a carriage that is operative to move a selected one of the plurality of data storage disks between the storage location and an access location. A read-write head associated with the access location is operative to read and write data to and from a selected data storage disk when the data storage disk is located at the access location. Accordingly, the access location may further include a drive hub operative to engage a central aperture of the data storage disk and rotate the data storage disk around the drive axis of the hub.

In order to securely engage a selected data storage disk with the drive hub, the drive hub may include one or more restraining elements that are operative to selectively engage the data storage disk, for example, proximate to the central aperture of the data storage disk. In one arrangement, the restraining elements may be disposed on and/or around a portion of the hub that is disposable through the central aperture of the selected data storage disk. Accordingly, such restraining elements may be moved from an initial position, or open position, to a subsequent, or clamped, position. In such a clamped position, the restraining elements may physically engage a surface of the data storage disk. Further, in the clamped position, the outside dimension, or diameter, of the restraining elements may be greater than the diameter of the central aperture of the data storage disk. Accordingly, in such a position the storage disk may be restrained on the drive hub. Further, the restraining elements may apply a compressive force to a surface of the storage disk and/or apply an outward force (e.g., relative to the drive axis) to the central aperture of the storage disk. Such an outward force may assist in properly centering the storage disk on the drive hub.

According to another aspect, the data storage device includes a housing that includes a plurality of data storage disks at a storage location therein and a disk access device disposed therein. The disk access device includes a rotating hub and at least one read-write head. A carriage disposed within the housing is operative to move between the storage location and the disk access device. Accordingly, the carriage may transport a selected one or more of the plurality of data storage disks between the storage location and the disk access device. The selected disk(s) may then be engaged with the rotating hub for rotation about a drive axis of the hub.

In one arrangement, the housing is a substantially sealed housing. In this regard, the data storage device may be a stand-alone device that may be utilized as an external storage device and/or in conjunction with a plurality of such devices in, for example, a silo arrangement. The housing may further include an input/output port that is in data communication with the read-write head. Further, such an input/output port may provide power for powering devices within the housing, including, without limitation, the read-write head, the rotating hub (e.g., a spin motor), a drive for the carriage and/or one or more actuators for positioning the storage disks. The housing may also include a port for equalizing pressure inside the housing with ambient pressure. Such a port may be filtered to prevent contaminants from entering the housing. In one arrangement, a maximum outside dimension of the housing is no greater than three times the diameter of the data storage disks located therein. In any arrangement, the housing may include a multitude of data storage disks. For instance, the housing may include at least three disks, and more typically between three and 50 disks. However, it will be appreciated that in other arrangements the housing may be sized to store additional disks.

In a further arrangement, the housing may include a second disk access device, including a second read-write head and a second rotating hub. In such an arrangement, the carriage may be operative to transport disks to both disk access devices and/or separate carriages may be utilized to transport disks to separate disk access devices. Further, it will be appreciated that a plurality of disk access devices may be incorporated in a common housing. In any arrangement, the rotating hub may allow for selectively engagement with two or more disks in a stacked configuration. In this regard, the drive hub may be operative to rotate two or more disks simultaneously.

In an arrangement utilizing two or more disk access devices, these disk access devices may be utilized simultaneously and/or redundantly. Further, the multiple access devices may be synchronized by a controller to run in tandem. In this regard, data storage/retrieval may be performed in, for example, a RAID configuration such that high data transfer/retrieval rates are possible.

To permit increased density of storage disks within the housing, the data storage disks may be stored in a stacked configuration (e.g., side by side). Further, a maximum spacing between the adjacent data storage disks may be less than twice the thickness of one of the data storage disks. In a further arrangement, a maximum spacing between adjacent data storage disks may be less than the thickness of one of the data storage disks. In this regard, a rack structure having a plurality of parallel grooves may be utilized to hold individual disks when not in use. In one arrangement, a U-shaped rack is utilized having first and second opposing surfaces with corresponding sets of grooves therein. In this arrangement, disks may be slid into a set of grooves within the U-shaped structure. In any arrangement, one or more stop devices may be operative to move into and out of the grooves to maintain individual disks within their grooves until they are selected for access. Accordingly, when selected for access, the stop device may be moved from the groove(s) to permit a selected disk to pass through the groove(s).

In order to remove the storage disks from the storage location, the storage structure may utilize individual actuators that are operative to move the storage disks. Alternatively, the storage structure may utilize gravity to load selected data storage disks into the carriage. For instance, a U-shaped member may be inverted and upright such that disks are inserted into grooves within the concave surface of the structure and are maintained within the grooves by a stop member. When the stop member is removed from the groove, the data storage disk may be operative to drop into the carriage for transport to the disk access device. One or more movable elements/actuators may be utilized to control the drop of the data storage disks to prevent damage thereof.

The carriage may include any movable member that is operative to support a data storage disk in a desired orientation and transport that data storage disk to the data access device for engagement therewith. In one arrangement, the carriage includes a bearing surface that is adapted to receive an edge of a selected data storage disk. The carriage may further include a latch/catch that is operative to engage a data storage disk when supported by the carrier. In this regard, such a catch may maintain the data storage disk in a fixed positional relationship with the carriage during transport. The carriage may further include one or more actuator devices that are operative to move a data storage disk supported therein to a desired position. For instance, such an actuator may be operative to apply a force to an edge of the disk in order to lift the disk from the bearing surface to, for example, a storage structure.

The carriage may include any drive mechanism that permits controlled movement thereof. Such drive mechanisms may include, without limitation, ball screws, lead screws, motors and/or gears. In one arrangement, the drive mechanism includes a motor and a single-tension element that is looped around a plurality of pulleys associated with the carriage and the housing. In such an arrangement, the carriage may move on one or more rails in a planar motion. For instance, the carriage may move a planar surface of a storage disk supported thereon in a direction that is aligned with the drive axis of the rotating hub of the disk access device.

According to another aspect, a method is provided for use in a data storage device. The method includes selecting one of a plurality of data storage disks and moving the selected data storage disk from the storage location to a drive hub. The central aperture of the data storage disk may then be engaged with the drive hub. The data storage disk may then be accessed. That is, the drive hub may be operative to rotate the disk such that a read-write head may access one or both surfaces of the data storage disk. Accordingly, once the access procedure is finished, the data storage disk may be disengaged from the hub and transported from the hub back to the storage location.

In a further arrangement, a second of the plurality of data storage disks is selected and moved to the drive hub, wherein the first disk remains engaged with the drive hub. The central aperture of the second data storage disk may then be engaged with the drive hub. At such time, both data storage disks may be rotated and accessed.

According to another aspect, a device is provided for use with a data storage device. Specifically, a hub for use with a spin motor of a data access device is provided that is operative to engage and disengage the central aperture of a data storage disk. The hub includes a stud that is sized for receipt within a central aperture of a data storage disk. Such a stud may be annular such that it may be conformably received within the central aperture of the data storage disk. In any case, the stud is symmetric about a rotational axis of the hub. A flange extends radially outward from the base of the stud and, hence, the rotational axis. The flange is adapted to support a planar surface of a data storage disk that is disposed about the stud. At least one restraining element or a plurality of restraining elements associated with the hub are operative to move between a first position that is located within a boundary defined by the central aperture of a data storage disk (i.e., when disposed about the stud) and a second position outside of the boundary defined by the central aperture of the data storage disk.

Such restraining elements may be interconnected to a portion of the stud that extends through the central aperture of a data storage disk disposed about the stud. In this regard, the restraining elements may have an initial diameter (i.e., in the first position) that permits their passage through the central aperture of the data storage disk. When moved to the second position, the restraining elements may have a diameter that is greater than the diameter of the central aperture of the data storage disk. Further, the restraining elements may be operative to apply compressive force to a surface of the data storage disk. In this regard, the data storage disk may be compressed between the restraining elements and the flange. In one arrangement, the restraining elements include a plurality of levers that are pivotally interconnected to the stud. Such levers may be operative to rotate in a plane that is parallel with the surface of the data storage disk or transverse to the surface of the data storage disk. A plurality of such levers may be equally spaced about the rotational axis and may extend radially outward in the second position.

In a further arrangement, the stud of the hub may have a length that allows for first and second storage disks to be placed on the drive hub in a stacked and spaced configuration. In such an arrangement, the drive hub may include first and second sets of restraining elements and or a retractable flange (e.g., similar to the restraining elements) for the second data storage disk. Alternatively, a spacer or bushing may be selectively positionable about the stud between the first and second data storage disks. In such an arrangement, two data storage disks may utilize a common set of restraining elements to compress both storage disks relative to a support.

According to another aspect, a method is provided wherein a data storage disk may be selectively engaged with a rotating hub of a data access device. The method includes disposing a central aperture of a data storage disk over a centering stud of a drive hub. Once so disposed, a restraining element that is movably connected with the centering stud may be moved from a first position that is within an area defined by the boundary of the central aperture to a second position that is outside the boundary defined by the central aperture. Accordingly, the restraining element may restrain the data storage disk to the hub.

According to another aspect, a storage structure for storing a plurality of data storage disks is provided. The structure includes first and second spaced supports wherein a plurality of corresponding sets of grooves are formed on the facing surfaces of the first and second spaced supports. Each set of grooves is sized to receive opposing edges of a data storage disk. A corresponding plurality of stop members are selectively positionable into and out of at least one groove of each of the set of grooves. Movement of the stop member into and out of the groove permits the data storage disk to be retained within the set of grooves or move out of the set of grooves, respectively. In one arrangement, the data storage disk may move out of the rack under the force of gravity when the first and second supports are in an upright position. The stop members may further include an actuator that is operative to move the stop member into and out of the grooves. In one arrangement, the stops are operative to rotate into and out of the grooves.

In one arrangement, the first and second supports collectively define a concave member. In such an arrangement, the corresponding sets of grooves may be formed on a concave surface of the concave member and may be continuous about the concave surface. In one arrangement, the concave surface is at least partially defined by first and second curves. These first and second curves may have equal radii and/or offset centers.

In one arrangement, the plurality of data storage disks may be disposed in the grooves in a side-by-side manner. Accordingly, the central apertures of these disks may be disposed along a common axis. In order to increase the number of disks that are held by the member, a maximum spacing between adjacent grooves may be less than the thickness of a data storage disk held by the sets of grooves.

According to another aspect, first and second multiple disk storage devices are utilized together to define a storage device. In such an arrangement, at least first and second disk drive devices are provide wherein each disk drive device includes a drive hub, a plurality of storage disks that are selectively engageable with the drive hub and a read/write head that is operative to access a storage disk that is engaged with the drive hub. A controller is in communication with the first and second disk drive devices. This controller may be operative to control the operation of both devices. Further, it will be appreciated that a plurality of such disk drive devices may be interconnected to form, for example, an array.

In any arrangement, the controller may link the disk drive devices to a computer system such that data may be exchanged between the computer system and the disk drive devices. In this regard, such a computer system may be co-located with the disk drive devices, or the computer system may be remotely located. In the latter regard, the disk drive devices may be interconnected to the computer system by one or more communications networks. These various connection methods may include, without limitation, PSTN, the Internet, the Worldwide Web, Ethernet connections, local area networks, wide area networks, fibre channel interfaces, Universal Serial Bus (USB) interfaces, Serial ATA, SCSI, wireless network connections, or any other standard or proprietary data interface.

The controller may be operative to selectively control first and second disk drive devices such that they operate simultaneously. In a further arrangement, the controller and disk drive devices may be configured in any of a plurality of RAID configurations. Accordingly, the disk drive devices may be operative to work simultaneously to provide improved throughput, reading and writing, searching and any form of data access. The plurality of disk drive devices may be hardwired together in the array. In this regard, appropriate data communication cables may be connected to the input/output port of each device and routed to the controller.

In another arrangement, a plurality of multiple disk storage devices may be utilized in a repository storage structure. In such a repository setting, a plurality of disk drive devices may be stored in an inactive condition for selective retrieval. Such disk drive devices may each include a plurality of data storage disks that are selectively engageable with the drive hub and a read/write head that is operative to access a data storage disk as engaged with the drive hub. The read/write head is in communication with the data port associated with the disk drive device. A carriage assembly may be utilized to engage and transport the disk drive device from the repository to an access location. Once at the access location, the data port and/or a power port may be engaged to supply power to the disk drive device as well as data communication with the read/write head therein. Accordingly, the disk drive device may be controlled to access one of the plurality of data storage disks stored therein. That data storage disk may be engaged with the drive hub and accessed. In this regard, data may be written to and/or read from the data storage disk. Once data is read or written to the disk drive device, the data and/or power port may be disengaged, and the disk drive device may be transported back to the repository.

### BRIEF DESCRIPTION OF THE DRAWINGS

FIG. 1A illustrates a perspective view of a housing of a data storage device.

FIG. 1B illustrates a first perspective exploded view of the device of FIG. 1.

FIG. 1C illustrates a second exploded perspective view of internal components of the device of FIG. 1.

FIG. 2 illustrates a storage rack for holding a plurality of data storage disks.

FIG. 3 illustrates an inside surface of the rack of FIG. 2.

FIG. 4 illustrates a perspective view of a data storage disk disposed within the rack of FIG. 2.

FIG. 5 illustrates a stop mechanism of the rack of FIG. 2.

FIG. 6 illustrates a cross-sectional end view of a data storage disk disposed within the rack of FIG. 2.

FIG. 7 illustrates a first perspective view of a device for lowering data storage disks from the storage rack of FIG. 2 to a carriage assembly.

FIG. 8 illustrates a second perspective view of the device for lowering storage disks.

FIG. 9 illustrates a carriage assembly for transporting data storage disks.

FIG. 10 illustrates a data storage disk disposed within the carriage.

FIG. 11 illustrates the carriage at a first position.

FIG. 12 illustrates the carriage of FIG. 11 at a second position.

FIG. 13 illustrates a data storage disk connected to a drive hub after transport by the carriage of FIGS. 11 and 12.

FIG. 14 illustrates a first embodiment of a drive hub having a plurality of engagement elements in an open configuration.

FIG. 15 illustrates the drive hub of FIG. 14 with the engagement elements in a closed position.

FIG. 16 illustrates a second embodiment of a drive hub having differently configured engagement elements.

FIG. 17A illustrates a data storage disk engaged with a drive hub.

FIG. 17B illustrate a drive hub that selectively engages two data storage disks.

FIG. 18 illustrates an actuator on the carriage assembly displacing a data storage disk.

FIG. 19 illustrates a process for moving a data storage disk between a storage structure and a drive hub.

FIG. 20 illustrates a plurality of multiple disk storage devices utilized in an array.

### DETAILED DESCRIPTION

Reference will now be made to the accompanying drawings, which assist in illustrating the various pertinent features of the inventions disclosed herein. Although described primarily herein in conjunction with the use of rigid magnetic disks for storage of data, it should be expressly understood that certain aspects may be applicable to other applications. For instance, certain aspects of the inventions may be applicable to optical storage media. In this regard, the following description is presented for purposes for illustration and description. Furthermore, the description is not intended to limit the embodiments to the forms disclosed herein. Consequently, variations and modifications consistent with the following teachings, in skill and knowledge of the relevant art, are within the scope of the present invention.

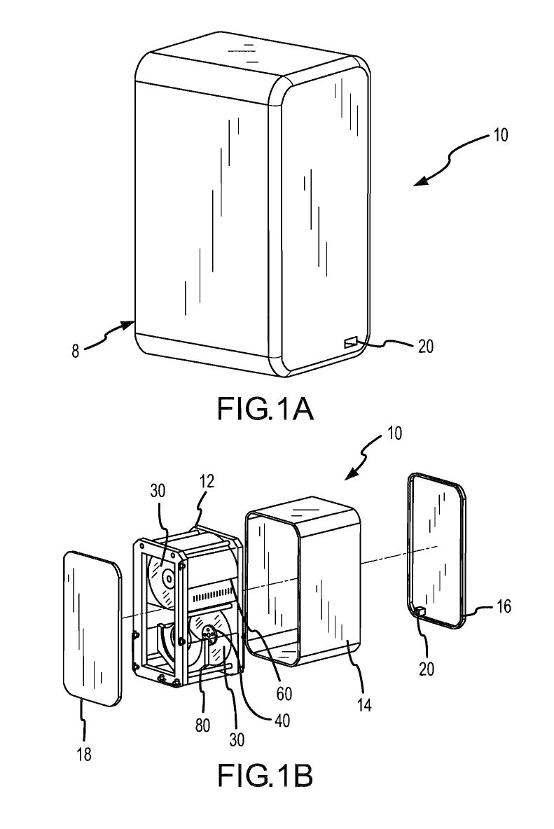

FIGS. 1A, 1B and 1C illustrate a perspective and two exploded perspective views, respectively, of a multiple disc storage device 10 that provides high capacity storage. More specifically, the device 10 includes a plurality of rigid magnetic data storage disks 30. Each of these disks 30 is individually selectable for engagement with disk access device 4 (e.g., a disk drive). Generally, the disk access device 4 includes a drive hub 40 attached to a spin or drive motor that is operable to rotate the drive hub 40 about a drive axis. Individual data storage disks 30 may be selectively engaged with the hub 40. The hub 40 is operative to spin the selected disk while a read/write head 6 is moved into position relative to the surface of the disk 30. As shown, the plurality of data storage disks 30 are stored side-by-side in a storage structure or rack 60. A carriage assembly 80 is operative to move a selected data storage disk 30 between the storage structure 60 and the drive hub 40 for engagement therewith, as will be more fully discussed herein.

As shown, the rack 60, which holds the plurality of data storage disks 30, the hub 40 and the carriage 80 are mounted in a common frame 12. Further, this frame 12 and the components supported therein are disposed within a housing 8 having a central portion 14 and first and second end caps 16, 18. As shown, the frame 12 and supported components are sized for receipt within a central portion 14 of the housing. Accordingly, the end caps 16, 18 may be interconnected to the central portion 14 of the housing and/or the frame 12. Once assembled, the housing 8 may be substantially sealed prevent particulates or other contaminates from entering an interior of the housing. The housing 8 may include one or more input ports 20 that allow for electrical and data communication between the components within the housing and external devices. Further, one or more filtered vent ports may be provided (not shown) that allow for equalizing internal pressure of the housing with ambient pressure. The function of components of the device including the rack 60, the carriage assembly 80 and drive hub 40 will now be discussed in detail.

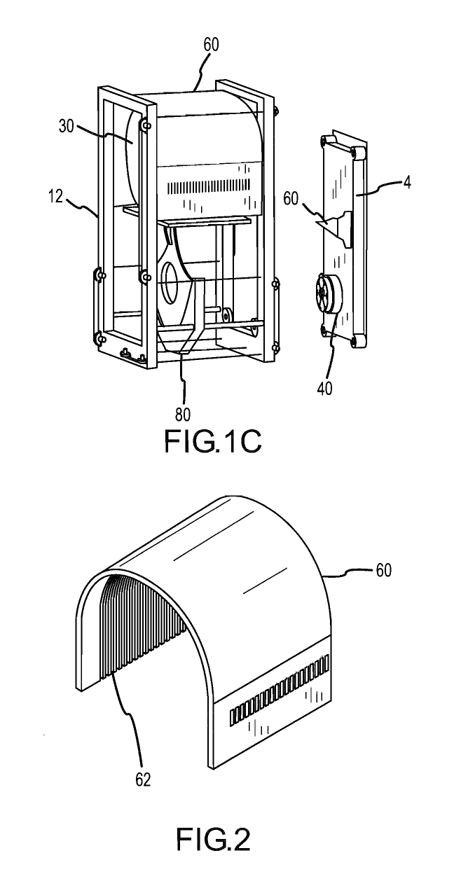

As noted above, the device 10 includes a storage structure or rack 60 that is operative to hold a plurality of data storage disks 30. As shown in FIGS. 2-5, the rack 60 is generally defined as a concave member having a plurality of grooves on the inside/concave surface thereof. Stated otherwise, the rack 60 is generally formed as a horseshoe or U-shaped member that has a plurality of grooves 62 that extend around its inside surface and which are sized to receive an individual data storage disk. In this regard, each groove 62 is operative to engage opposing sides of a single data storage disk therein. Further, the concave rack 60 is sized such that each groove engages a radial portion of the disks 30 to provide additional support for the disks, as will be further discussed herein. In the present embodiment, the rack 60 includes a series of fifty parallel grooves 62 around its inside surface. Accordingly, the rack 60 is adapted to store fifty individual data storage disks therein. However, it will be appreciated that racks 60 having different capacities (e.g., larger and smaller) are contemplated and considered within the scope of the disclosure.

The rack 60 is designed to be in an upright position such that the open end of the concave surface faces downward. Accordingly, disks 30 disposed within the grooves 62 may be removed from the rack 60 by gravity. In this regard, individual actuators are not necessary to remove the disks 30 from the grooves. This may reduce the space required between the disks and simplify the device 10. However, in other arrangements/embodiments, individual actuators may be utilized to move disks in and/or out of the rack. That is, other embodiments of the device may not rely on gravity for movement of the disks 30.

In the present embodiment, the spacing between individual disks and the plurality of grooves 62 is minimized to increase the storage capacity of the device 10. In this regard, the spacing between individual grooves 62 is only about 1.2 times the thickness of the disks themselves. This spacing allows the disks 30 to be inserted and removed from their respective grooves without contacting adjacent disks.

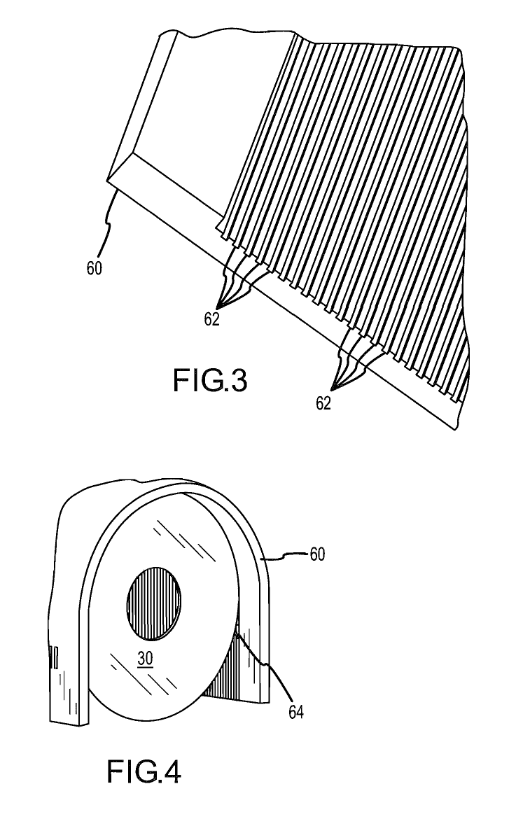

In order to retain the plurality of storage disks 30 within their respective grooves 62, each groove 62 includes a movable stop or blocking lever 64 that is positionable into and out of each groove. See FIGS. 4 and 5. In one or more retention positions, each blocking lever 64 disposed in that groove intrudes into its respective groove such that a data storage disk is restrained at the closed/rounded end of the rack 60. See FIG. 4. The blocking levers 64 are pivotally interconnected to the rack 60. The pivot of the levers 62 are located such that a force applied by the disk 30 results in a normal force on the lever that passes generally through the pivot. This makes the function of the blocking lever 64 substantially insensitive to external shocks may act to move the disks from their restrained position. Further, each blocking lever 64 is lightly sprung to the blocking/retention position. That is, each blocking lever 64 may include a spring that maintains an inside portion of the lever 64 within its groove 62. Further such spring loading of the blocking levers 64 may allow for each lever to be displaced by a data storage disk 30 as it is inserted into the rack 60. Once the data storage disk 30 passes beyond the lever 64, the lever may move back into the groove 62 in order to restrain the data storage disk 30 within the rack 60.

In order to remove a data storage disk 30 from the rack 60, a second end or outside portion of the levers 64 may extend beyond an outside surface of the rack 60. See FIG. 5. Accordingly, by selectively depressing the outside end of a lever 64, the inside end of the lever may be removed from its groove 62 and thereby permit a data storage disk 30 to move past the lever. Although FIGS. 4 and 5 show a single lever for purposes of illustration, it will be appreciated that a series of levers, one for each disk 30 and groove 62 are utilized. Further, it will be appreciated that individual actuators may be operative to depress individual levers 64 such that each lever may be actuated independently without disturbing the lever 64 on either side of the actuated lever. In this way, any disk in the rack may be selected for retrieval.

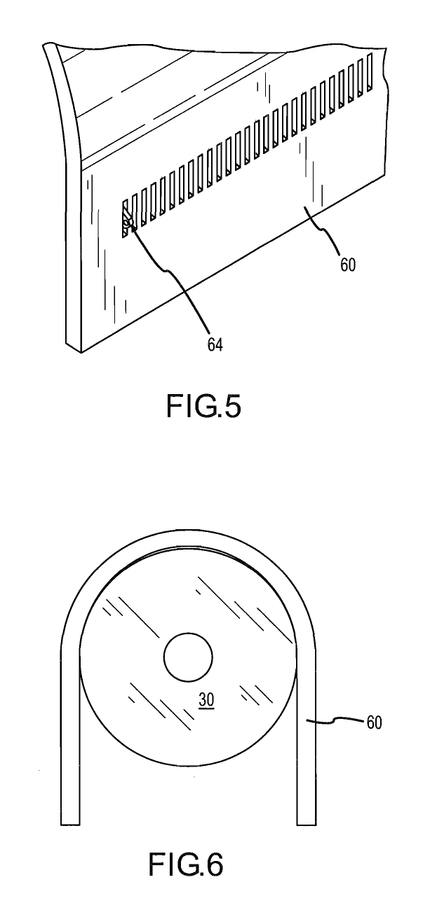

FIG. 6 illustrates an end view of a data storage disk 30 disposed within an individual groove in the rack 60. As shown, each groove of the rack 60 is shaped such that it makes line contact with an outside edge of the disk 30. Further, to prevent the disks 30 from becoming caught within the grooves while still maintaining contact with a radial portion of an outside edge of the disk, the rack 60 is formed as what may be termed a gothic arch. That is, the concave inside surface of the rack 60 is formed by two distinct curves whose centers are offset such that each disk 30 makes definite tangential contact at two separate locations. In this regard, each groove may provide significant support for a disk 30 supported therein. However, as the curvature of the rack 60 and groove are not identical to the outside curvature of the disk 30, the likelihood of the disk 30 becoming stuck within the groove 62 is reduced or eliminated.

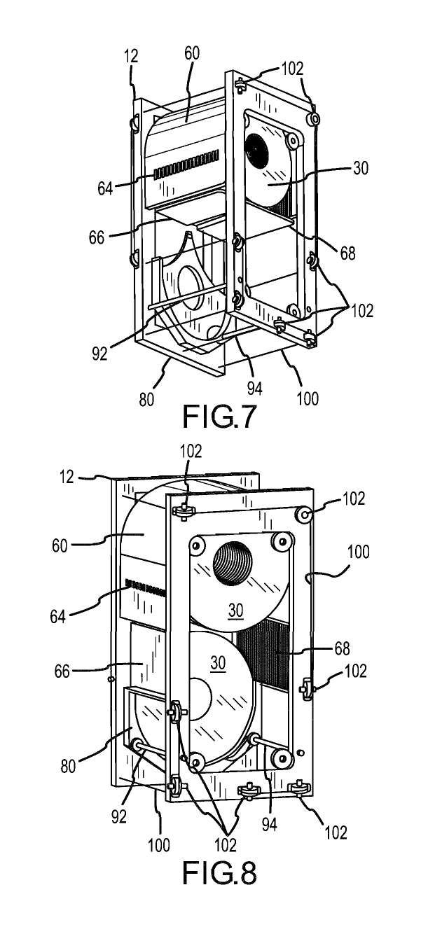

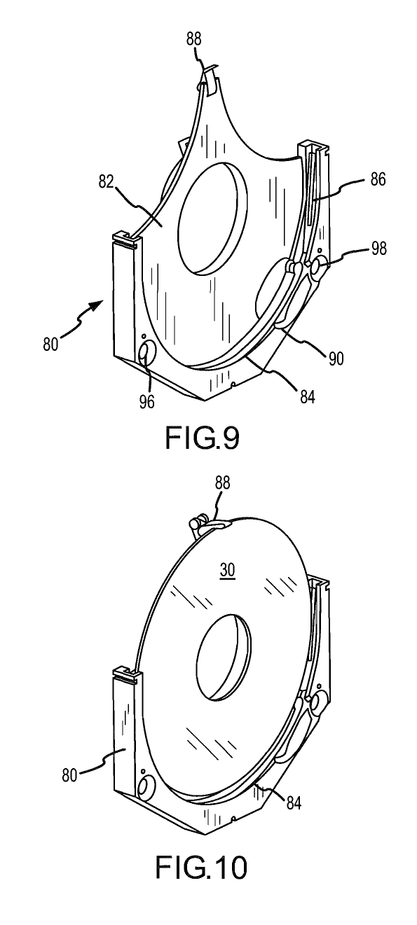

Once a disk 30 is selected for retrieval, the disk moves from its storage location within the rack 60 to the carriage assembly 80 for transfer to and engagement with drive hub 40. In the present arrangement, where the disk 30 moves under the force of gravity from the storage location in the rack 60 to the carriage assembly 80, it is important that such movement be controlled or otherwise attenuated to prevent damage of the disk 30. To achieve such controlled movement, the present device 10 utilizes first and second disk lowering devices or flappers 66, 68 that allow for controlled movement of a selected disk 30 from the storage position in the rack 60 to a transfer position in the carriage assembly 80. See FIGS. 7 and 8. As shown, these flappers, 66, 68 are formed of two grooved plates. The grooves on the flappers 66, 68 correspond to and are in alignment with the grooves in the rack 60. As illustrated in FIG. 7, the flappers 66, 68 may be rotated fully against the disks 30 disposed within the rack 60. Further, as shown in FIG. 9, the flappers 66, 68 may be rotated to a parallel position with the side surfaces of the rack 60. Typically, the flappers 66, 68 are rotated against the disks 30 within the rack 60 to immobilize the disks 30 and protect them from external shocks. In one arrangement, the region of the flapper 66, 68 that contacts the disks 30 is a soft material to help absorb shocks and distribute contact loads on the disks.

Upon individual disk selection by actuation of one of the blocking levers 64, the flappers 66, 68 are rotated down and out to allow the selected disk 30 to (e.g., under the force of gravity) move downward along its groove 62. The flappers 66, 68 are moved in angular unison, rotating outward in opposite directions to guide and lower the selected disk 30. The remaining disks are held in their storage locations within the rack 60 by their corresponding blocking levers. As the selected disk 30 is lowered by the flappers 66, 68, the disk is received by the carriage assembly 80, which is adjacent to and in alignment with the position of the selected disk 30 during the lowering process.

As shown in FIG. 9, the carriage assembly 80 includes a body 82 having a curved bearing surface 84 for supporting a data storage disk 30. Opposing edges of the curved bearing surface 84 include two grooved levers or flippers 86 (only one shown). These flippers 86 are designed such that they may be brought into alignment with the grooves in the rack. Accordingly, as the flappers 66, 68 rotate downward and the disk 30 is lowered due to gravity, it comes into contact with the grooves in the levers or flippers 86. When the flappers 66, 68 have rotated to the full out position, and while the grooves in the flappers 66, 68 are still engaged with the disk 30, the flippers 86 rotate inward to engage the disk. The disk may then settle to the bottom of the curved bearing surface 84.

Once the disk is disposed on the bearing surface 84, a lever or gripper 88 may be rotated such that a groove on the gripper 88 meets with the top edge of the disk 30. See FIG. 10. At this point, the disk is fixedly positioned relative to the carrier, and the flappers 66, 68 may be rotated further outward to completely disengage the disk 30. See FIG. 7. The disk may then be transported by the carriage assembly 80 to the drive hub 40.

As shown, the carriage assembly 80 moves on rails 92, 94 that are supported by the frame 12 of the data storage device 10. As shown, the body of the carriage assembly 80 has one circular aperture 96 and one slotted bearing surface 98 that are adapted to engage the rails 92, 94, respectively. See for example FIG. 9. Use of this slotted bearing surface facilitates linear motion of the body even when the rails 92, 94 are not perfectly parallel. The circular aperture and the bearing surface include bearings that engage the rails 92, 94. The rails 92, 94 and bearings act to constrain two degrees of freedom of the carriage assembly 80. Accordingly, the carriage body 82 and a supported data storage disk 30 may move along the rails. Motion along the rails may be achieved with ball screws, ball less lead screws or any number of other ways known to those skilled in the art. In the current embodiment, a single tension element 100 is looped around numerous pulleys 102 rotatably supported by the frame 12. The tension element may be, for example, and without limitation, a monofilament polymer or a steel strand, a multi-strand polymer or a cable, or a flat belt. As shown, the configuration of the tension element 100 and the pulleys 102 is such that any motion of the tension element 100 results in unidirectional linear motion of three parallel sections of the tension element 100. Due to the continuity of the tension element 100, the three parallel sections move in exact synchronicity.

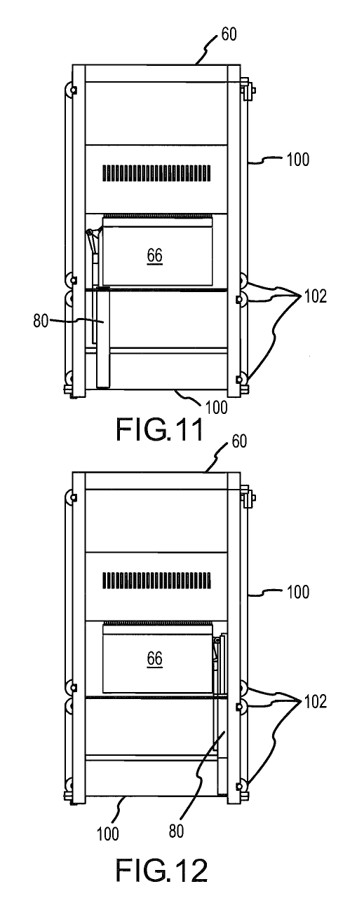

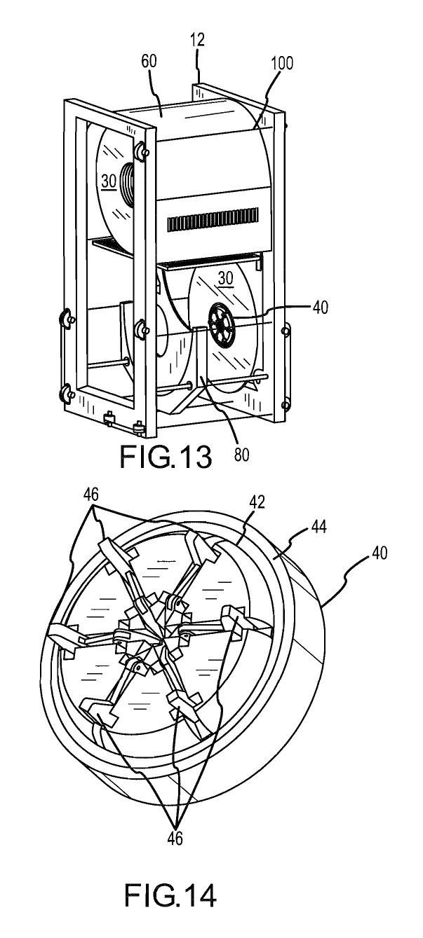

Accordingly, the body 82 of the carriage assembly 80 is attached to the tension element 100 at three points, one in each corner of the carriage body 82. Attachment may be achieved with a setscrew, a clamp, adhesive or other appropriate fasteners. The tension element 100 may be moved by a motor or other drive source (not shown). As the tension element 100 is moved, the body of the carriage assembly 80 moves with precise planar motion parallel to the grooves in the rack 60 and along the rails 92, 94. This movement is illustrated in FIGS. 11 and 12 which show the carriage assembly 80 moving from a first edge of the frame 12 to a second edge of the frame towards the drive hub 40. More specifically, the carriage assembly 80 transports the selected data storage disk 30 adjacent to and in alignment with the drive hub 40. Engagement elements of the drive hub 40 clamp the disk 30 onto the drive hub 40. The flippers 86 and gripper 88 then rotate away from the disk 30, thereby releasing the disk from the carriage assembly 80. The disk 30 is then loaded onto the drive hub 40 and the carriage assembly may be moved away from the disk 30 such that the disk is free to rotate. See FIG. 13

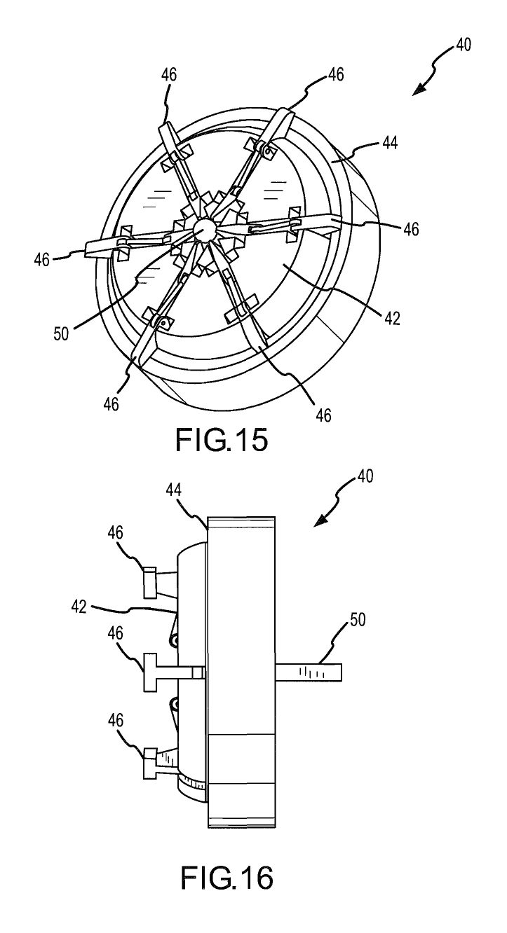

As will be appreciated, magnetic storage devices/hard disk drives operate at high revolutions. For instance, it is not unusual for drive motors to rotate storage disks at speeds in excess of 5,000 RPM. Accordingly, it is necessary in a removable data storage device 10 to provide accurate alignment of the data storage disk 30 with the drive hub 40 as well as to securely fasten the disk 30 to the hub 40. FIGS. 14-16 illustrate two embodiments of a hub 40 having disk engagement elements for securing removable data storage disk 30 and the drive hub 40. As shown, the drive hub 40 is generally circular to provide rotational balance at high revolutions. The drive hub 40 includes a raised stud 42 that is sized for conformal receipt within the aperture of a data storage disk 30. A planar flange 44 extends radially outward from the base of the stud 42. This flange 44 provides a support surface against which the periphery of the disk 30 about its central aperture may be compressed. To facilitate loading of the data storage disk 30 onto the stud 42, the stud is tapered between its top edge and its base. However, this is not a requirement.

As shown, the hub 40 includes a plurality of disk engagement elements 46 that are equally positioned about the hub 40. In this regard, each restraining element 46 is equally spaced around the drive axis of the hub 40. In the present embodiment, each restraining element includes a four-bar lever mechanism that is actuated by a common plunger 50, which passes through the center of the hub 40 and through the center of a corresponding motor shaft. When the plunger 50 is in a first position, the restraining elements 46 may each be in a open configuration, as shown in FIGS. 14 and 16. In such an open configuration, the restraining elements may each be completely disposed within the perimeter of the mounting stud 42. Stated otherwise, none of the restraining elements may be disposed at a distance from the drive axis that is greater than the radius of the control aperture of the data storage device. Accordingly, in such an open position, the central aperture of a data storage disk may be disposed over the mounting stud 42 such that the restraining elements 46 pass through the central aperture.

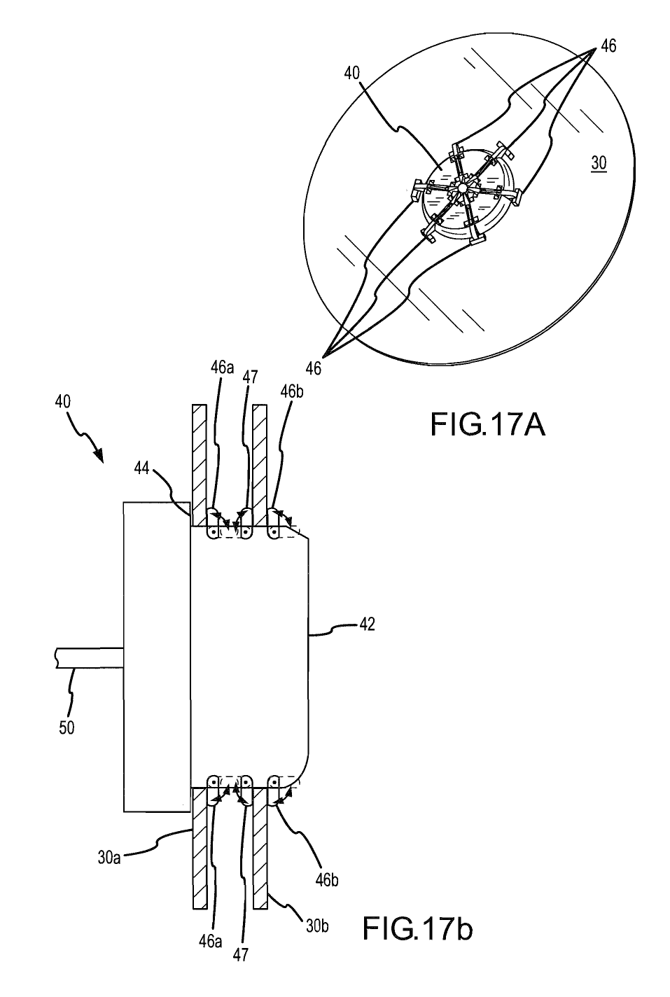

When the plunger 50 is in a second position, the restraining elements 46 may be moved to a closed or locked position. Further, use of the four-bar mechanism may allow the restraining elements 46 to swing down against a disk and secure it against the motor hub flange 44, see FIG. 17. Such four-bar mechanisms may be designed to move to an over-center condition during clamping to enhance their clamping force.

Once the data storage disk 30 is disposed around the hub 40 and clamped thereto, read/write heads may be moved from a stowed position to a position relative to the surface or surfaces of the disk. Accordingly, a load ramp may be utilized to move the heads from the stowed position to the surface of the disks. Such load ramps may be radially positioned away from motor (i.e., the drive axis) such that the read/write heads are clear of the disk radius. When the read/write heads are positioned adjacent to the disk surfaces, the operation of the device 10 is substantially the same as a standard hard drive device. Accordingly, the disk 30 may be rotated, and data may be read from the disk or written to the disk.

FIG. 17b illustrates another embodiment of a drive hub 40 that may be utilized with a variant of the device 10. The drive hub 40 is again circular to provide rotational balance at high revolutions. However, the raised stud 42 that is sized to conformally receive first and second data storage disks 30a and 30b. To facilitate receipt of two data storage disks, the hub 40 of FIG. 17b utilize a first set of disk engagement elements 46a to clamp a first data storage disk 30a to a flange 44. A retractable flange may then be deployed. For instance, a plurality of flange elements 47 may, after a first disk 30a is engaged against the flange, move from a stowed position within the circumference of the stud 42 to a deployed position to define a second flange. A second data storage disk 30b may then be placed about the stud and a second set of disk engagement elements 46b may then clamp the second data storage disk 30b against the flange elements. It will be appreciated that the various disk engagement elements 46a, 46b and flange elements 47 may be staggered about the perimeter of the stud 42. Such an arrangement allows for accessing two data storage disks selectively engaged with a common hub 40.

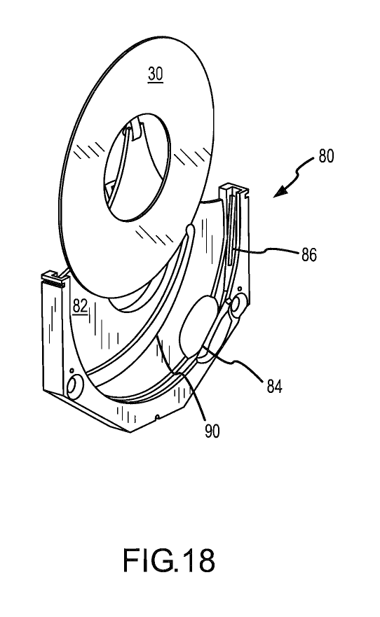

Once access to the disk is no longer needed, the disk may be moved back to the storage location within the rack 60. Accordingly, the read/write head may be stowed, the carriage assembly 80 may move adjacent to the disk 80 and the flippers 86 and gripper 88 may re-engage the disk. The restraining elements 46 of the hub 40 may then release the disk. The carriage assembly 80 may then move to the location along the length of the rack 60 that corresponds to the storage location of the selected storage disk 30. As shown in FIG. 18, a lifter 90 associated with the bearing surface 84 or the carriage assembly 80 may then be actuated to lift the disk back into the storage rack 60. Accordingly, the disk may be received within its assigned groove 62 until it passes the blocking lever 64 and is thereby restrained in the rack. At such time, another disk may be selected for use with the device 10.

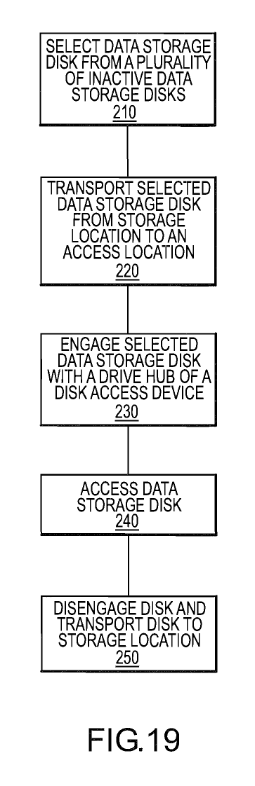

FIG. 19 broadly illustrates the process for selecting and moving a disk between the rack 60 and the drive hub 40. Initially, a data storage disk is selected (210) from the plurality of data storage disks. Such selection may be based on known index information associated with the plurality of disks, or on information stored on a different disk within the device, or on information stored in internal memory in the controller device, or information stored on a separate storage device or computer, or any other method suitable for providing such index information. In any case, once the disk is selected (210), the disk may be moved (220) from the rack 60 to the drive hub 40. Such movement (220) may entail the actuation of one or more retention elements that maintain the disk within the rack. Further, such movement may entail movement in the first direction and movement in a second direction. For instance, in the present embodiment, the disk may move down from the rack 60 to the carriage assembly 80. This movement is generally aligned with the surface of the disk. The carriage assembly 80 may then transport the disk in a direction that is normal to the surface of the disk to the drive hub 40. Once the data storage disk is moved (220) from the storage location to the drive hub 40, the central aperture of the data storage disk may be engaged (230) with the drive hub 40. Once so engaged, the drive hub 40 may be operative to rotate the data storage disk about its drive axis. Accordingly, once the disk is engaged with the drive hub 40, the disk may be accessed (240) to read data from and/or write data to the disk.

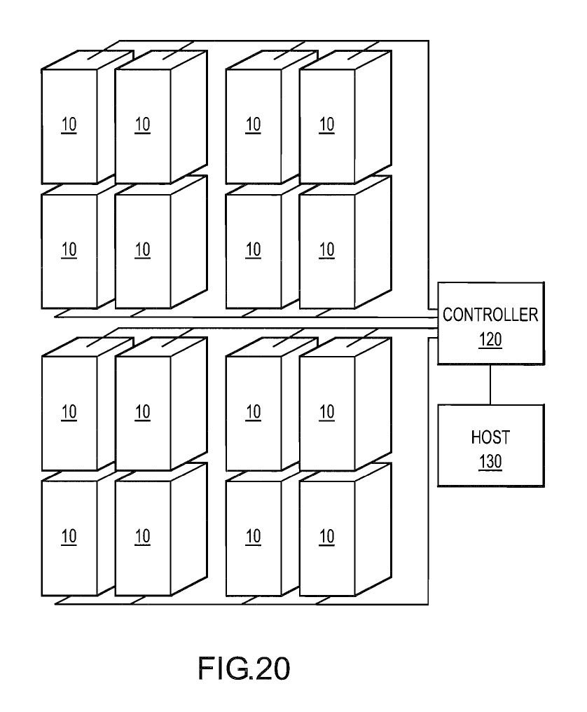

The multiple disk storage device 10, may be utilized as an independent external storage device. In this regard, a data and/or power cable may be interconnected to the input/output port to connect the device 10 to a computer system. However, it will be appreciated that in other arrangements a plurality of multiple disk storage devices 10 may be utilized together. As shown in FIG. 20, it will be noted that a plurality of the devices 10 may be utilized together in an array. In such an arrangement, the plurality of devices 10 may be connected to a common controller 120 that is operative to individually control or synchronize the operation of the devices 10. Further, the controller is operative to link the devices 10 to one or more computer systems, which may be co-located or remote systems.

The interconnected devices 10 may be utilized in a RAID system (i.e., redundant array of independent disks). In such a system, the RAID system configures an array multiple devices 10 into a single logical unit. For instance, when utilized in a RAID system consisting of an array of multiple disk storage devices 10, each desk within each individual device 10 of the array may be treated as a single standard hard disk drive. As such, conventional algorithms, error correction schemes, and/or other means to provide data redundancy and protection from loss can be applied over a set of disks. For instance, two disks or devices in the array may make mirror copies of data. This may be useful when read performance is more important than capacity, for example, to allow searching and retrieving data from both disks simultaneously to reduce search and retrieval time. Further, data may be split across two or more disks in the array during writing to improve throughput. As will be appreciated, in cases where a device 10 fails and a copy of the data exists, the device may be replaced (e.g., hot swapped) and data from a mirror copy device may be replicated on the new device. In short, any RAID configuration may be realized.

To allow use of such conventional algorithms, all devices in the array may change to a different disk simultaneously. During such change, data flow to or from the array may be interrupted or may be cached on a separate data storage structure (e.g., hard drive) that is not part of the RAID array. Such RAID configurations are typically (but not necessarily) implemented with identically sized disk drives. Accordingly, the disks within each device 10 may be of equal sizes.

It will be appreciated that a set of disks across the devices that are utilized to form a RAID do not have to be related or ordered. The set may be synchronized where disk 1 from all the devices in the array are used together, or the set of disks may be random or in any other combination. The only requirement is at the same set of disks that make up a RAID array is mounted across all the devices 10 in the array during read or write operations. An array of these devices could also be configured such that some subset of the disks are configured as RAID system while the remaining disks could act as independent standalone disks. Further, the array could be made up of devices 10 that do not have the same number of disks. In such an arrangement, a RAID array could be configured across an array of the devices 10 where the RAID systems is applied across all the devices 10 on any number of disks up to the number of disks that is contained by the device 10 having the minimum number of disks. Any remaining disks, not part of the RAID array could be treated as independent disks.

When a plurality of the devices are utilized together, the devices 10 may be hard mounted to a common structure or frame. However, in other arrangements, the devices may be movable between a storage location and an access location. For instance, a plurality of the devices 10 may be utilized in an arrangement similar to a data silo where a plurality of the devices are ‘shelved’ when not in use. When a particular device is required, the device may be selected and transported, for example by a carriage assembly, to an access location where a data and/or power cable may be connected to the input/output port of the device 10 to permit access to the disks stored therein. In such an arrangement, dozens, hundreds or even thousands of the devices 10 may be utilized.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. For instance, the data storage device may be modified to include two or more separate disk access devices. In this regard, the device may include multiple sets of drive hubs and multiple sets of read/write heads to allow for simultaneously accessing separate disks. Likewise, the device may include two or more carriage assemblies for transporting disks to the separate drive hubs. Therefore, the embodiments described hereinabove are intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A data storage device, comprising:
a plurality of data storage disks;
a carriage operative to move a selected one of said plurality of data storage disks between a storage location and an access location; and
a read/write head associated with said access location, wherein said read/write head is operative to read and write data to and from said selected data storage disk when said selected data storage disk is located at said access location.

2. The device of claim 1, further comprising:
a drive hub located at said access location, said drive hub being operative to engage a central aperture of said data storage disk and rotate said data storage disk about a drive axis.

3. The device of claim 2, wherein a center point of said central aperture of said data storage disk is normal to a storage axis when disposed in said storage location, wherein said drive axis and said storage axis are non-aligned.

4. The device of claim 2, wherein at least a portion of said drive hub is sized to extend through said central aperture.

5. The device of claim 2, wherein said disk drive hub further comprises:
at least one restraining element operative to selectively engage said data storage disk proximate to said central aperture.

6. The device of claim 5, wherein said at least one restraining element moves between an open position and a clamped position, wherein said restraining element physically engages said data storage disk in said clamped position.

7. The device of claim 6, wherein a maximum dimension of said restraining element in said open position, as measured from said drive axis, is less than a radius of said central aperture, wherein said restraining element may pass through said central aperture in said open position.

8. The device of claim 6, wherein a dimension of said restraining element in said clamped position as measured from said drive axis is greater than a radius of said central aperture.

9. The device of claim 6, wherein said restraining element comprises at least a first lever.

10. The device of claim 2, further comprising:
a housing for housing said plurality of data storage disks, said carriage, said read/write head and said drive hub; and
an input/output port passing through said housing and being in data communication with said read/write head.

11. The device of claim 10, wherein said housing is substantially sealed.

12. The device of claim 11, further comprising:
a vent for equalizing pressure within said housing with ambient pressure.

13. The device of claim 1, wherein said plurality of data storage disks comprise a plurality of magnetic storage disks.

14. The device of claim 1, wherein said read/write head further comprises:
first and second read/write heads that are disposable on opposing surfaces of a data storage disk at said access location.

15. The device of claim 1, wherein said read/write head is movable between a stowed position and a read/write position adjacent to a surface of a data storage disk located at said access location.

16. A method for use in a data storage device, comprising:
selecting a data storage disk from a plurality of data storage disks;
moving said data storage disk from a storage location to a drive hub;
engaging a central aperture of said data storage disk with said drive hub, wherein said drive hub is operative to rotate said data storage disk about a drive axis; and
accessing said data storage disk, wherein accessing includes at least one of reading data from said data storage disk and writing data to said data storage disk.

17. The method of claim 16, wherein moving further comprises:
first moving said data storage disk in a first direction having a component normal to said drive axis; and
second moving said data storage disk in a direction substantially aligned with said drive axis.

18. The method of claim 16, wherein moving further comprises:
passing a portion of said drive hub through said central aperture of said data storage disk.

19. The method of claim 18, wherein engaging comprises:
restraining said data storage disk about said central aperture.

20. The method of claim 19, wherein restraining comprises moving at least a first restraining element associated with a portion of said drive hub extending through said central aperture from an open position to a clamping position.

21-24. (canceled)

25. A data storage device, comprising:
a housing;
a plurality of data storage disks disposed at a storage location within said housing;
a disk access device disposed within said housing, said disk access device including a rotating hub and at least one read/write head; and
a carriage disposed within said housing, wherein said carriage is operative to move a selected one of said plurality of data storage disks between said storage location and said disk access device, wherein said selected disk is engageable with said rotating hub for rotation about a first axis.

26. The data storage device of claim 25, said housing further comprising:
an input/output port for transmitting data to and from said disk access device.

27-30. (canceled)

31. The data storage device of claim 25, wherein a maximum spacing between adjacent data storage disks within said storage location is less than twice a thickness of one of said data storage disks.

32. The data storage device of claim 31, wherein a maximum spacing between adjacent data storage disks within said storage location is less than 1.5 times the thickness of one of said data storage disks.

33. The data storage device of claim 25, wherein said storage location further comprises:
a rack having a plurality of parallel grooves, each of said grooves being sized to receive an edge of one of said storage disks.

34. The data storage device of claim 33, wherein said rack has first and second spaced and surfaces, wherein said spaced surfaces include corresponding sets of grooves, wherein each set of grooves are adapted to received opposing edges of one of said data storage disks.

35. The data storage device of claim 34, wherein at least one groove of each set of grooves includes a stop that is selectively positionable into and out said groove, wherein said at least one stop prevents passage of a data stage disc through said set of grooves in at lest one direction when positioned in said groove.

36-37. (canceled)

38. The data storage device of claim 33, wherein said rack comprises a concave member having said grooves on a concave surface.

39-41. (canceled)

42. The data storage device of claim 25, wherein the carriage further comprises:
a body having a bearing surface for supporting an edge surface of a selected one of said data storage disks; and
a latch member movable from a first position to a second position, wherein in said second position said latch member engages a data storage disk supported by said bearing surface and maintains said data storage disk relative to said bearing surface while said carriage moves.

43. The data storage device of claim 42, further comprising:
an actuator for selectively applying a force between said bearing surface and a data storage disk supported by said bearing surface.

44. canceled

45. The data storage device of claim 25, further comprising a drive mechanism for controllably moving said carriage.

46. The data storage device of claim 45, further comprising:
a sensor for identifying the position of said carriage relative to a predetermined reference position.

47-49. (canceled)

50. The data storage device of claim 25, wherein said disk access device is a first disk access device and said carriage is a first carriage, further comprising:
a second disk access device disposed within said housing and including a second rotating hub and at least one read/write head; and
a second carriage disposed within said housing, wherein said carriage is operative to move a selected one of said plurality of data storage disks between said storage location and said second disk access device, wherein said selected disk is engageable with said second disk access device for rotation about a second axis.

51-52. (canceled)

53. The data storage device of claim 25, wherein a maximum outside dimension of said housing is less than three times the diameter of one of said plurality of data storage disks.

54. The data storage device of claim 25, further comprising:
a plurality of selectively controllable storage disk actuators, wherein each of said storage disk actuators is operative to at least initiate movement of one of said data storage disks between said storage location and said carriage.

55-91. (canceled)
